(19) United States
(12) Patent Application Publication
(10) Pub. No.: US 2002/0135237 A1
(43) Pub. Date: Sep. 26, 2002

(54) High inrush current limiting switch assembly

(76) Inventor: N. Dale Baker, Ellijay, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/785,871

(22) Filed: Feb. 16, 2001

Related U.S. Application Data
(60) Provisional application No. 60/182,964, filed on Feb. 16, 2000.

(51) Int. Cl. H02H 3/00

(52) U.S. Cl. 307/115

(57) ABSTRACT

An improved switch assembly that substantially reduces the high inrush current that initially flows through switch-activated devices. The switch assembly includes multiple poles connected in parallel. Each pole has a set of electrical contacts. A current limiting mechanism is connected in series with the contacts of at least one of the poles. Upon activation of the switch assembly, the contacts connected to the current limiting mechanism close before the contacts of the other poles. The initial current is forced to flow through the pole with the current limiting mechanism, which thereby reduces the initial current level flowing through the switch-operated device. The contacts of the remaining poles close almost immediately thereafter, establishing a lower-resistance connection between the load and power source. The switch assembly may also include a circuit breaker to open the circuit if a predetermined current level is exceeded.

This utility patent application claims priority to provisional U.S. patent application No. 60/182,964.

### FIELD OF THE INVENTION

The present invention relates generally to an improved switch assembly that initially resists inrush current flow (i.e., transient current surge) through the switch assembly and thereby substantially reduces the inrush current flowing into a device activated by the switch assembly.

### BACKGROUND OF THE INVENTION

Numerous different switches are found in the prior art. For example, single pole single throw (“SPST”) switches, double pole single throw (“DPST”) switches, and double pole double throw (“DPDT”) switches, all available in a variety of different packages, including, for example, push-button, rocker, illuminated rocker, toggle, paddle, miniature toggle and paddle, sub-miniature toggle, automotive, and slide switches, offer convenient off-the-shelf solutions when a switch is required that provides for a single pole single throw operation, a double pole single throw operation, and a double pole double throw operation, respectively.

Mechanical switches operate in the same general manner. Upon activation of the switch, the contacts of the switch close, thereby closing the circuit and allowing current to flow. When the circuit is first closed, depending on the circuit load, a high initial inrush current may flow through the switch and into the device activated by the switch. While the current flow eventually stabilizes, the device is often unable to handle this repeated high inrush of current every time the device is activated and eventually will fail. The high inrush current thereby significantly reduces the life of the device. Transient high current demands can also be undesirable for other reasons. For instance, commercial power charges are sometimes based, in part, on a customer's peak demand, and higher peak demands result in higher charges.

In an attempt to reduce the high inrush current, mechanisms that resist and reduce current flow, such as resistors, have been incorporated into switches. U.S. Pat. No. 5,907,270 to Branston et al., entitled “Current-Limiting Switch,” discloses incorporation of a plurality of resistor bodies into a switch. The resistor bodies, however, decompose and evaporate upon use. As a result, the device described in Branston et al. is not capable of being reset and may be used only once.

Moreover, current limiting mechanisms such as resistors remain permanently in the circuit and therefore constantly resist and reduce current flow during operation of the device (at least until they decompose), not just during the initial period when the inrush current is damagingly high. Permanent inclusion of these devices in the circuit thereby results in inefficient use of the current and power loss.

### SUMMARY OF THE INVENTION

The present invention solves the above-mentioned problems by providing an improved switch assembly that substantially reduces the high inrush current that initially flows through switch-activated devices. The switch assembly includes multiple poles connected in parallel. Each pole has a set of electrical contacts. A current limiting mechanism is connected in series with the contacts of at least one of the poles. Upon activation of the switch assembly, the contacts connected to the current limiting mechanism close before the contacts of the other poles. The initial current is forced to flow through the pole with the current limiting mechanism, which thereby reduces the initial current level flowing through the switch-operated device. The contacts of the remaining poles close almost immediately thereafter, establishing a lower-resistance connection between the load and power source. The switch assembly may also include a circuit breaker to open the circuit if a predetermined current level is exceeded.

Reduction of inrush current can significantly prolong the life of the device. Moreover, reducing current flow through the current limiting mechanism after the initial inrush period improves the efficiently of the circuit and reduces power loss. Additionally, unlike previous switches that incorporate current limiting mechanisms to limit current flow, because the amount of current running through the current limiting mechanism is reduced, the mechanism does not degrade or decompose and therefore may be used repeatedly.

It is an object of the present invention to provide a switch assembly that substantially impedes high inrush current normally associated with switch assembly-activated devices.

It is another object of the present invention to provide a switch assembly that prolongs the life of switch-activated devices.

It is still another object of the present invention to provide an inrush current reducing switch assembly that also includes a circuit breaker.

It is another object of the present invention to provide a switch assembly that substantially reduces high inrush current through more than one activation of a switch-activated device.

It is yet another object of the present invention to provide an inrush current reducing switch assembly compatible with a variety of switch packages.

### BRIEF DESCRIPTION OF THE DRAWINGS

FIG. 1 is a schematic diagram of the circuitry of one embodiment of the switch assembly of the present invention.

FIG. 2 is a schematic diagram of the circuitry of an alternative embodiment of the switch assembly of the present invention.

FIG. 3 is a schematic diagram of the circuitry of an alternative embodiment of the switch assembly of the present invention.

FIG. 4 illustrates one side of one embodiment of the switch assembly of the present invention in the “OFF” position.

FIG. 5 illustrates the opposite side of the switch assembly of FIG. 4 in the “OFF” position.

FIG. 6 illustrates the switch assembly of FIG. 4 in the “ON” position.

FIG. 7 illustrates the switch assembly of FIG. 5 in the “ON” position.

FIG. 8 illustrates one end of the switch assembly shown in FIGS. 5 and 6.

FIG. 9 illustrates the opposite end of the switch assembly shown in FIG. 8.

### DETAILED DESCRIPTION OF THE DRAWINGS

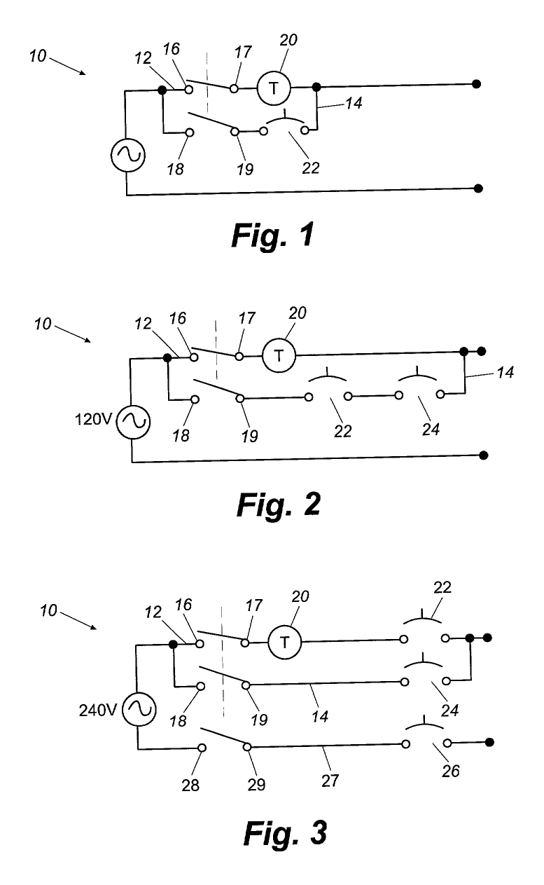

FIG. 1 illustrates the circuitry of one embodiment of the switch assembly of the present invention. While FIG. 1 illustrates a DPST switch, the switch assembly of the present invention is not limited to DPST switches. Rather, other types of switches, including a triple pole single throw switch (see FIG. 3), may be built in accordance with the present invention whereby a current limiting mechanism is essentially electrically present in the circuit only momentarily to resist and reduce initial current flow.

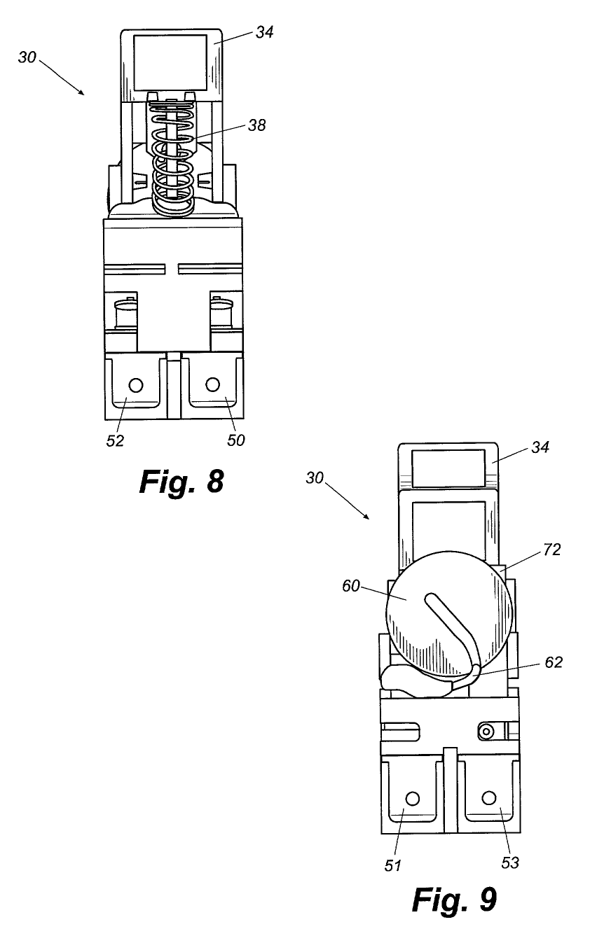

The switch assembly 10 of FIG. 1 includes a first pole 12 and a second pole 14 connected in parallel. Electrical contacts 16, 17 are associated with the first pole 12 and electrical contacts 18, 19 are associated with the second pole 14. Contacts 16, 17 of the first pole 12 are connected in series with a current limiting mechanism. While FIG. 1 illustrates a thermistor 20, any current limiting mechanism, including a resistor, resistor network, or similar device, may be used in the switch assembly 10. Upon activation of the switch assembly 10, pairs of contacts 16, 17 and contacts 18, 19 contact each other to close the circuit. The contacts 16-19 are preferably positioned to stagger contact closure so that contacts 16, 17 of the first pole 12 close before contacts 18, 19 of the second pole 14. As shown in FIGS. 1 and 8, staggered contact closure may be accomplished by maintaining contacts 18, 19 of the second pole 14 at a distance from each other greater than the distance between contacts 16, 17 of the first pole 12. Because contacts 16, 17 are positioned closer together, provided that the same mechanism simultaneously actuates both pairs of contacts 16, 17 and 18, 19, contacts 16, 17 engage first to close the electrical circuit. Current thereby flows through the first pole 12 and the thermistor 20 connected in series with contacts 16, 17 of the first pole 12. Thermistor 20 reduces the rate of flow of the current through the first pole 12 and through the device activated by the switch (not shown).

Almost (but not quite) immediately after the closure of contacts 16, 17, contacts 18, 19 of the second pole 14 close, allowing current to flow through the second pole 14 and bypass thermistor 20. While some current is still able to travel through the first pole 12, the amount of this current is negligible because the contacts 18, 19, upon closing, provide a very low resistance path through which current may flow. The purpose of the second pole, therefore, is to essentially electrically remove the thermistor 20 from the electrical circuit. The switch assembly may be configured so that, upon engagement of contacts 18, 19, contacts 16, 17 disengage to prevent any current flow through the first pole.

As disclosed in FIG. 1, the switch assembly of the present invention may, but does not have to, incorporate a circuit breaker 22. FIG. 2 and 3 illustrate alternative embodiments of the switch assembly of the present invention having multiple circuit breakers. In FIG. 2, an additional circuit breaker 24 is incorporated into the switch assembly 10. Likewise, in FIG. 3, two additional circuit breakers 24, 26 as well as an additional pole 27 with contacts 28, 29 are incorporated into the switch assembly 10.

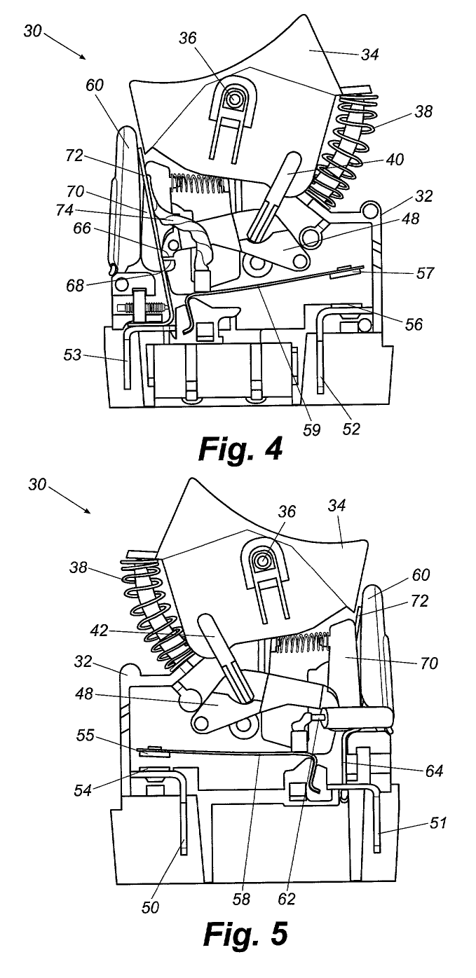

FIGS. 4-9 illustrate a possible physical embodiment of a two pole single throw switch assembly 30, such as that of FIG. 1, built in accordance with the present invention. Internal or external jumps (not shown) connect the poles in parallel to the power source (also not shown). While FIGS. 4-9 illustrate a rocker switch, numerous other embodiments of the switch assembly of the present invention are possible. The switch assembly of the present invention may be packaged in any form that is desirable, including, but not limited to, push-button, rocker, illuminated rocker, toggle, paddle, miniature toggle and paddle, sub-miniature toggle, automotive, and slide switches.

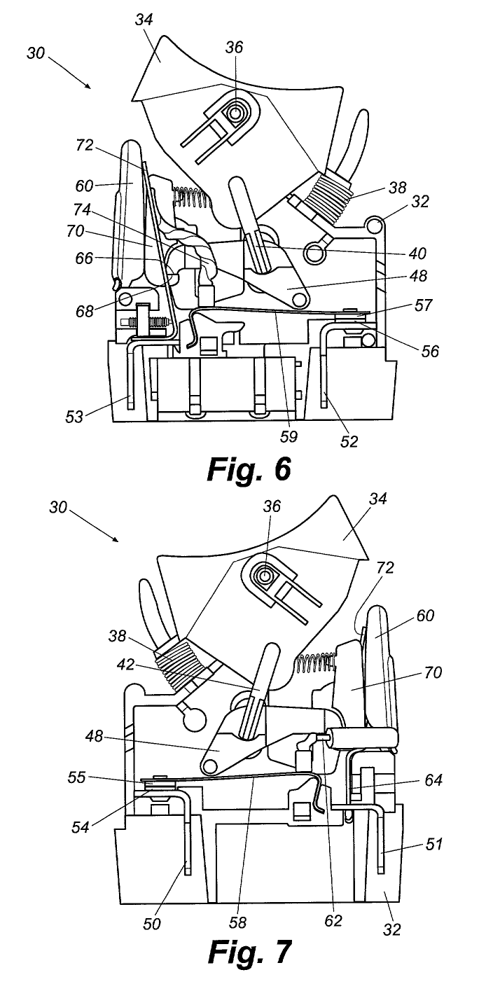

The switch assembly 30 of FIGS. 4-9 includes a switch assembly body 32 onto which the circuitry elements are mounted and a rocker 34 to control current flow through the switch assembly. The switch assembly body 32 has a pin 36 that extends through the rocker 34, thereby allowing the rocker 34 to pivot around the pin 36 between an “ON” position (shown in FIGS. 6 and 7) and an “OFF” position (shown in FIGS. 4 and 5). The rocker 34 engages a spring 38 mounted on the switch assembly body 32 to provide resistance and prevent inadvertent pivoting of the rocker 34 into the “ON” position.

Tabs 40, 42 connected to rocker 34 engage vertical moving member 48 of the switch assembly body 32. Four connectors 50-53 are located on the switch assembly 30. The switch assembly 30 also includes a first set 54, 55 and a second set 56, 57 of electrical contacts. Electrical contacts 54, 56 are mounted on connectors 50, 52, respectively. Electrical contacts 55, 57 are positioned on a first contact arm 58 and a second contact arm 59, respectively. When the switch assembly 30 is “OFF,” contacts 56, 57 are maintained at a greater distance from each other than the distance between contacts 54, 55.

In the embodiment of FIGS. 4-9, electrical contacts 54, 55 are connected in series with a thermistor 60 by a first wire 62. A second wire 64 feeds out of the thermistor 60 and engages connector 51.

Depressing the rocker 34 towards the “ON” position (see FIGS. 6 & 7) causes the rocker 34 to rotate about pin 36 and compress spring 38. Tabs 40, 42, forced down by the rocker 34, in turn, force the vertical moving member 48 to which the tabs 40, 42 are engaged to move down as well. The vertical moving member 48 thereby contacts the contact arms 58, 59, pushing the contact arms 58, 59 and consequently the contacts 55, 57 fixed on the contact arms 58, 59 toward the contacts 54, 56 mounted on connectors 50, 52. Because contacts 54, 55 start closer together, they close the circuit first, allowing current to flow through the connector 50, contact arm 58, first wire 62, thermistor 60, second wire 64, and connector 51 (see FIG. 7). Thermistor 60 significantly reduces the current through the device while only contacts 54 and 55 are closed.

When rocker is fully depressed, contacts 56, 57 engage (see FIG. 6), allowing current to flow in a lower resistance circuit through connector 52 and out connector 53 into the device. The time between closure of the first set of contacts 54, 55 and the second set of contacts 56, 57 may be adjusted for particular applications, but is preferably between 3/10 and 7/10 of a second. The pressure exerted by tabs 40, 42 onto the vertical moving member 48 ensures that contacts 54-57 remain closed when the switch assembly 30 is “ON.” Moreover, a lip 66 located on the vertical moving member 48 locks in ledge 68 of horizontal pivoting member 70 to lock the rocker 34 in the depressed position.

When the rocker is depressed toward the “OFF” position, tabs 40, 42 move upwards, allowing the vertical moving member 48 to rotate upwards and lip 66 of the vertical moving member 48 to dislodge from ledge 68 of horizontal pivoting member 70. Upward movement of the vertical moving member 48 relieves the downward pressure exerted by the vertical moving member 48 on the contact arms 58, 59. The contact arms 58, 59 consequently move upwards and the contacts 54-57 disengage, opening the circuit and discontinuing current flow through the switch assembly 30.

The switch assembly of the present invention may, but does not have to, incorporate a circuit breaker, such as that disclosed in U.S. Pat. No. 5,894,260 to Cella et al., the entirety of which is herein incorporated by reference. The circuit breaker may be triggered using thermal sensing means. A bimetallic strip 72 is incorporated into the switch assembly 30 of FIGS. 4-9 (see FIGS. 4, 6, and 9, specifically). Strip 72 is connected, for example by soldering, to connector 53. A third wire 74, for example a pigtail wire, connects the strip 72 to the contact arm 59. The strip 72 rests against the horizontal pivoting member 70 of the switch assembly body 32. Current enters connector 52 and passes through the contact arm 59, strip 72, and out of connector 53. If too much current flows through the strip 72, the strip will heat up and bow or arch against the horizontal pivoting member 70. The force of the strip 72 against the horizontal pivoting member 70 causes the horizontal pivoting member 70 to pivot, thereby dislodging the lip 66 of the vertical moving member 48 from its ledge 68. The vertical moving member 48 consequently moves up, releasing pressure from the contact arms 58, 59 which, in turn, move to disengage the contacts 54-57, thereby opening and discontinuing current flow through the switch assembly 30.

In the switch assembly 30 of FIGS. 4-9, the thermistor 60 may also “trip” the circuit breaker. The thermistor 60 is mounted on the switch assembly 30 adjacent to the bimetallic strip 72. As current flows through the thermistor 60, the temperature of the thermistor 60 increases. If too much current flows through the thermistor 60, which can happen if the operator fails to completely depress the rocker into the “ON” position so that the second set of contacts 56, 57 do not close and therefore do not electrically remove the thermistor 60 from the circuit, the thermistor 60 heats up to such an extent that the heat emitted from the thermistor 60 causes the adjacent bimetallic strip 72 to bow or arch. Such bowing can lead to deactivation of the switch assembly 30 as discussed previously.

The foregoing is provided for the purpose of illustrating, explaining and describing embodiments of the present invention. Further modifications and adaptations to these embodiments will be apparent to those skilled in the art and may be made without departing from the spirit of the invention or the scope of the following claims.

What is claimed is:

1. A switch assembly comprising at least a first and a second pole connected in parallel and at least one current limiting mechanism connected in series with the first pole, wherein, upon activation of the switch assembly, current initially flows solely through the first pole and the at least one current limiting mechanism but wherein the current subsequently flows substantially only through the second pole.

2. The switch assembly of claim 1, wherein the first pole comprises a first set of electrical contacts and the second pole comprises a second set of electrical contacts, wherein the first set of electrical contacts electrically engage before the second set of electrical contacts to allow the current to initially flow solely through the first pole but wherein, when the second set of electrical contacts electrically engage, current flows substantially only through the second pole.

3. The switch assembly of claim 1, further comprising at least one circuit breaker.

4. The switch assembly of claim 3, wherein the at least one circuit breaker is activated by thermal sensing means.

5. The switch assembly of claim 4, wherein the at least one circuit breaker comprises a bimetallic strip.

6. The switch assembly of claim 3, wherein the at least one current limiting mechanism is proximal to the at least one circuit breaker on the switch assembly.

7. The switch assembly of claim 1, wherein the at least one current limiting mechanism is a thermistor.

8. The switch assembly of claim 1, wherein the at least one current limiting mechanism is a resistor.

9. The switch assembly of claim 2, wherein the first set of electrical contacts disengage after the second set of electrical contacts electrically engage.

10. A switch assembly comprising at least a first pole having a first set of electrical contacts and a second pole having a second set of electrical contacts, wherein the first and second poles are connected in parallel and the first set of contacts is connected in series with at least one current limiting mechanism, wherein, upon activation of the switch assembly, the second set of contacts close after the first set of contacts close to facilitate current flow substantially only through the second pole.

11. The switch assembly of claim 10, wherein when the first set of electrical contacts close but before the second set of electrical contacts close, current flows solely through the first pole and the at least one current limiting mechanism.

12. The switch assembly of claim 10, wherein the switch assembly further comprises at least one circuit breaker.

13. The switch assembly of claim 12, wherein the at least one circuit breaker is activated by thermal sensing means.

14. The switch assembly of claim 13, wherein the at least one circuit breaker comprises a bimetallic strip.

15. The switch assembly of claim 12, wherein the current limiting mechanism is proximal to the at least one circuit breaker on the switch assembly.

16. The switch assembly of claim 10, wherein the at least one current limiting mechanism is a thermistor.

17. The switch assembly of claim 10, wherein the at least one current limiting mechanism is a resistor.

18. The switch assembly of claim 10, wherein the first set of electrical contacts open after the second set of electrical contacts close.

19. A method of reducing inrush current into a switch-activated device comprising:
a. first generating current flow through a first pole of a switch assembly, wherein a current limiting mechanism is connected in series with the first pole; and
b. second generating current flow through a second pole of the switch assembly, wherein the second pole is connected in parallel with the first pole.

20. The method of claim 19, wherein current flow is generated through the first pole by electrically engaging a first set of electrical contacts connected in series with the first pole.

21. The method of claim 20, wherein current flow is generated through the second pole by electrically engaging a second set of electrical contacts connected in series with the second pole after electrically engaging the first set of electrical contacts.

22. The method of claim 21, further comprising disengaging the first set of electrical contacts after the second set of electrical contacts electrically engage.
